(19) United States
(12) Patent Application Publication
(10) Pub. No.: US 2025/0166653 A1
(43) Pub. Date: May 22, 2025

(54) SIGNAL PROCESSING APPARATUS AND SIGNAL PROCESSING METHOD

(71) Applicant: SONY GROUP CORPORATION, TOKYO (JP)

(72) Inventors: YOUSUKE TAKAHASHI, TOKYO (JP); TOMOKI YAMASHIMA, TOKYO (JP); MARIKO YOSHIOKA, TOKYO (JP); TAKASHI KUDO, TOKYO (JP); YOSUKE HORIBA, TOKYO (JP)

(21) Appl. No.: 18/839,559

(22) PCT Filed: Jan. 17, 2023
(86) PCT No.: PCT/JP2023/001072

§ 371 Date: Aug. 19, 2024

(30) Foreign Application Priority Data
Feb. 25, 2022 (JP) 2022-027573

(51) Int. Cl. G10L 21/0364; G06F 3/16; G10L 21/034; G10L 25/30; G10L 25/84; H04S 3/00

(52) U.S. Cl. CPC G10L 21/0364; G10L 21/034; G10L 25/30; G10L 25/84; H04S 3/008; G06F 3/165; H04S 2400/01; H04S 2400/13

(57) ABSTRACT

To create, for example, an experience value of content. Provided is a signal processing apparatus including a feature extraction section that uses a learning model obtained through machine learning, to extract a signal of specific sound from an input signal, and a feature addition section that applies gain adjustment to the signal of the specific sound extracted in the feature extraction section and adds a result of the gain adjustment to a signal based on the input signal.

### TECHNICAL FIELD

The present disclosure relates to a signal processing apparatus and a signal processing method.

### BACKGROUND ART

There has been known a technology for increasing an experience value of content. For example, in PTL 1 below, as a technology which increases a sense of presence of live content, there is disclosed a technology which extracts audio (center sound) to be listened by audience in a live concert venue and adds the extracted center sound to an input signal, thereby clarifying the center sound.

### CITATION LIST

### Patent Literature

### PTL 1

JP 2015-99266A

### SUMMARY

### Technical Problem

Incidentally, in recent years, a demand for various kinds of entertainment content such as live content such as live sport broadcast, music content, and movie content has increased, and hence, it is desired to further create the experience value of the content.

One object of the present disclosure is to achieve creation of an experience value of content.

### Solution to Problem

The present disclosure is, for example, a signal processing apparatus including a feature extraction section that uses a learning model obtained through machine learning, to extract a signal of specific sound from an input signal, and a feature addition section that applies gain adjustment to the signal of the specific sound extracted in the feature extraction section and adds a result of the gain adjustment to a signal based on the input signal.

The present disclosure is, for example, a signal processing method including a feature extraction step of using a learning model obtained through machine learning, to extract a signal of specific sound from an input signal, and a feature addition step of applying gain adjustment to the signal of the specific sound extracted in the feature extraction step and adding a result of the gain adjustment to a signal based on the input signal.

### BRIEF DESCRIPTION OF DRAWINGS

FIG. 1 is a function block diagram for illustrating a configuration example of an information processing apparatus.

FIG. 2 is a view for illustrating a configuration example of a user interface.

FIG. 3 is a view for illustrating a configuration example of the user interface.

FIG. 4 is a view for illustrating a mode example of automatic setting.

FIG. 5 is a view for illustrating a mode example of the automatic setting.

FIG. 6 is a view for illustrating a configuration example of the user interface.

FIG. 7 is a diagram for illustrating a first configuration example of a signal processing section.

FIG. 8 is a diagram for illustrating a second configuration example of the signal processing section.

FIG. 9 is a diagram for illustrating a third configuration example of the signal processing section.

FIG. 10 is a flowchart for illustrating a processing example of the signal processing section.

FIG. 11 is a diagram for illustrating a hardware configuration example.

### DESCRIPTION OF EMBODIMENT

A description regarding an embodiment and the like of the present disclosure is now given with reference to the drawings. Note that the embodiment and the like described now are preferred specific examples of the present disclosure, and contents of the present disclosure are not limited to the embodiment and the like. The description is given in the following order.
<1. Embodiment>
[1-1. Configuration Example of Information Processing Apparatus]
[1-2. Setting Mode Examples]
[1-3. First Configuration Example of Signal Processing Section]
[1-4. Second Configuration Example of Signal Processing Section]
[1-5. Third Configuration Example of Signal Processing Section]
[1-6. Example of Processing by Signal Processing Section]
[1-7. Hardware Configuration Example]
<2. Modification Examples>

### 1. Embodiment

### 1-1. Configuration Example of Information Processing Apparatus

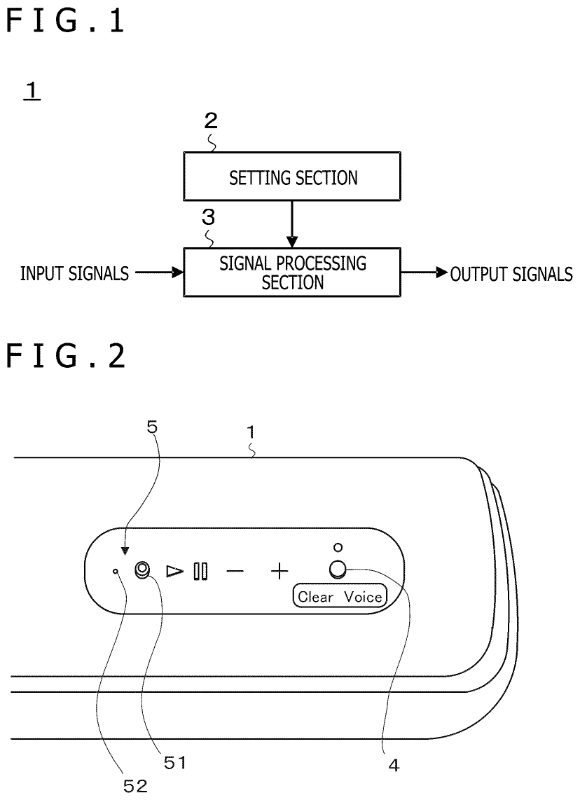

FIG. 1 illustrates a configuration example of an information processing apparatus (information processing apparatus 1) according to the embodiment of the present disclosure. The information processing apparatus 1 is a soundbar used in a home audio, a home theater, and the like. Note that the information processing apparatus 1 is not limited to the soundbar and may be another electronic apparatus such as a headphone, an earphone, a head-mounted display, an audio player, a smartphone, and a personal computer. In short, the information processing apparatus 1 is only required to be used for utilizing content (specifically, content including sound).

The information processing apparatus 1 makes it possible to adjust clarity and adjust localization of specific sound (hereinafter referred to as specific sound) of content, thereby achieving an increase in experience value. As the specific sound, for example, sound relating to voice such as a talk (Dialog) in live content such as live sport broadcast, a vocal in music content, and a line in video content is known. The sound relating to the voice herein is not limited to talking sound or singing sound of a person and includes voice in a broad sense (for example, laughing sound, crying sound, sighing sound, barking, and the like) and sound similar to the voice (for example, virtual sound of voice of a character or the like).

The information processing apparatus 1 includes a setting section 2 and a signal processing section 3. The setting section sets the adjustment of the clarity and the adjustment of the localization of the specific sound and outputs setting information according to the setting. The setting section 2, for example, acquires various types of information required for the setting and executes this setting on the basis of the acquired information. As these various types of information, for example, operation information according to an operation on a user interface (UI) such as a switch and a touch panel which a user can operate and sensing information according to a sensing result of a sensor device such as a camera or a microphone are known. These information acquisition source devices may be included or may not be included in the information processing apparatus 1. Moreover, connection between the information processing apparatus 1 and the information acquisition source device may be any one of wired connection and wireless connection. The setting information output by the setting section 2 is transmitted to the signal processing section 3.

The signal processing section (signal processing apparatus) 3 applies, to input signals, processing of the adjustment of the clarity or the adjustment of the localization of the specific sound and outputs signals obtained after the adjustment, as output signals. Note that the signal processing section 3 may adjust both the clarity and the localization. The adjustment thereof is executed according to the setting information supplied from the setting section 2.

The input signals input to the signal processing section 3 are supplied from, for example, another apparatus (for example, a television apparatus) connected to the information processing apparatus 1. The input signals may be any one of a one-channel (ch) signal, 2-channel signals, and multi-channel signals on channels equal to or more than the two channels. Note that the supply source device for the input signals may be, for example, a storage apparatus, a reception apparatus, or the like. These supply source devices may be included or may not be included in the information processing apparatus 1. Connection between the information processing apparatus 1 and the supply source device may be any one of wired connection and wireless connection.

The output signals are output to, for example, speakers (not illustrated) which the information processing apparatus 1 includes, and sound is then output. The number of channels which the output signals have may be the same as that of the input signals or may be different from that of the input signals obtained through the upmixing or the downmixing. Note that an output destination device for the output signals may be, for example, a storage apparatus, a transmission apparatus, or the like. These output destination devices may be included or may not be included in the information processing apparatus 1. Connection between the information processing apparatus 1 and the output destination device may be any one of wired connection and wireless connection.

The signal processing section 3 specifically extracts signals of the specific sound from the input signals, applies gain adjustment to the extracted signals of the specific sound, adds (the addition includes addition of adding a plus signal and subtraction of adding a minus signal) the signals obtained after the gain adjustment to signals based on the input signals, and outputs the signals obtained after the addition, as the output signals. The signal based on the input signal herein is the input signal or a signal obtained by applying predetermined processing to the input signal. As this predetermined processing, for example, separation processing, delay processing, upmixing processing, downmixing processing, and the like for the specific sound are known.

In a case in which the signal processing section 3 adjusts, for example, the clarity of the specific sound, the signal processing section 3 adds the signals of the specific sound extracted from the input signals, to the signals based on the input signals, to increase or reduce a signal level of the specific sound, thereby achieving the adjustment. Moreover, in a case in which the signal processing section 3 adjusts, for example, the localization of the specific sound, the signal processing section 3 appropriately adds, when the signals of the specific sound extracted from the input signals are added to the signals based on the input signals, the signals of the specific sound to any channel signals, thereby achieving the adjustment. A specific configuration example of the signal processing section 3 is described later.

### 1-2. Setting Mode Examples

A description regarding mode examples of the setting in the setting section 2 described before is now given. The setting of the adjustment of the clarity and the adjustment of the localization can be made through, for example, any one of the following three settings.
1. Uniform fixed setting is made through switching “a sound mode” (fixed setting).
2. The setting is automatically switched to a recommended setting through an external trigger (automatic setting).
3. A user changes the setting to a desired setting in real time through an application of a smartphone or the like (desired setting).

FIG. 2 illustrates a configuration example of a user interface for the setting. For example, the fixed setting described above can be achieved as described below. As illustrated in FIG. 2, for example, it is assumed that the information processing apparatus 1 includes a user-operable operation section 4. The operation section 4 is operated by the user in a case in which the user wants to increase the clarity of the specific sound (Voice in the illustrated example). The operation section 4 can include, for example, a push button switch as illustrated in FIG. 2, and, when the push button switch is pushed to ON, the information processing apparatus 1 operates in such a manner as to automatically increase the clarity of the specific sound. Specifically, in a case in which the push button switch is pushed, the above-described setting section 2 reads the fixed setting from the storage apparatus according to operation information thereon, thereby setting the setting information. The fixed setting is, for example, a setting which an audio setting person considers good. In a case in which the localization adjustment is set, there can be provided, for example, such a configuration that the switching is made by direction keys or the like.

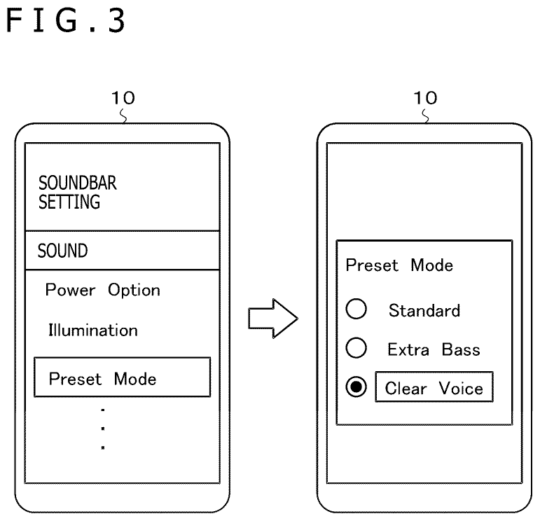

Note that there may be provided such a configuration that the adjustment of the clarity and the adjustment of the localization can be set from the application of the smartphone or the like. For example, as illustrated in FIG. 3, on a setting screen for the information processing apparatus 1 (soundbar in the illustrated example) of a smartphone 10, a setting similar to that by the operation section 4 can be made through a setting in a sequence of “Preset Mode” and “Clear Voice.” The setting for the localization adjustment is also similar thereto.

Moreover, for example, the automatic setting described above can be achieved as described below. As illustrated in FIG. 2, for example, it is assumed that the information processing apparatus 1 includes sensor devices 5 such as a camera 51 and a microphone 52. With this configuration, for example, there can be provided such a configuration that the information processing apparatus 1 uses the camera 51 to detect a user position and automatically adjusts the localization of the specific sound according to the detected user position. The user is not always present at a center position such as a home audio. Thus, for example, when the user is present on a right side with respect to the center position, the localization adjustment is made such that the sound on the left side is louder, thereby enabling the user to listen as in a case in which the user is present at the center position. Note that the clarity of the specific sound may be adjusted according to the user position.

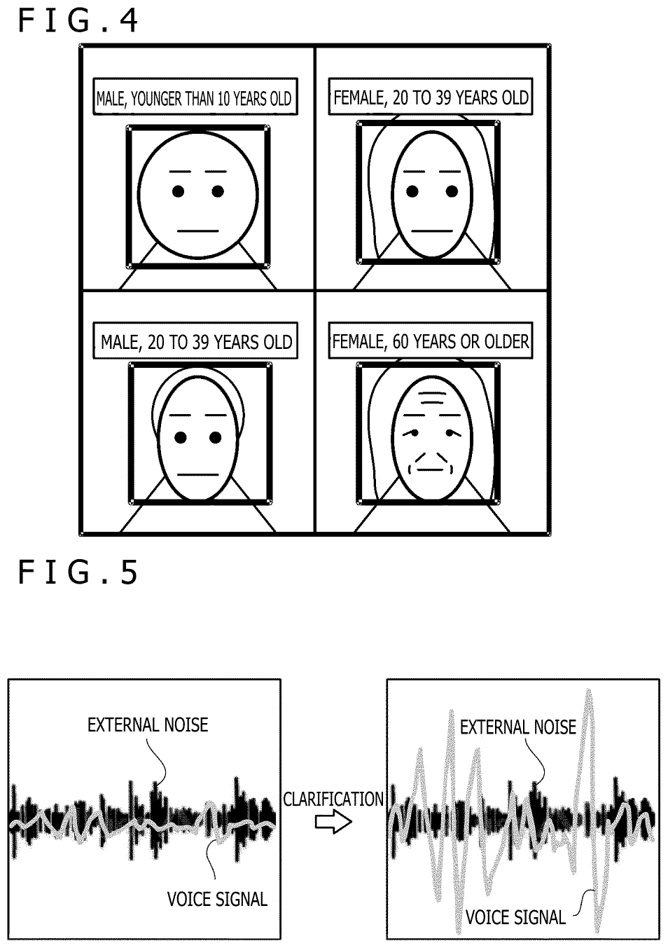

Moreover, the information processing apparatus 1 can be configured to use, for example, as illustrated in FIG. 4, the camera 51 to identify a user age and adjust the clarity of the specific sound according to the age. With this configuration, in a case in which an aged person is included in the user, the clarity may be increased to achieve an easy-to-listen state. Note that the localization may be adjusted according to the user age. As described above, the setting may automatically be made according to a result of image analysis of the camera 51. That is, the above-described setting section 2 may automatically set optimal setting information according to the sensing information of the sensor device. Note that it is possible to conceive such a configuration of allowing the user to use the application of the smartphone or the like to input the age information at the time of set setting of the home audio or the like and thereby achieve automatic adjustment to the optimal setting according to the input age and the like.

Further, there can be provided such a configuration that the information processing apparatus 1, for example, as illustrated in FIG. 5, uses the microphone 52 (see FIG. 2) to collect ambient sound and adjusts the clarity of the specific sound (voice in the illustrated example) according to a sound collection result. For example, it is possible to use the microphone 52 to detect a sound volume level of sound other than the specific sound (for example, external noise) and to make such automatic setting that the specific sound is more easily listened than sound other than the specific sound (for example, as illustrated in FIG. 5, a level of a voice signal is increased), thereby achieving the state in which the specific sound is easily listened to. Note that there may be provided such a configuration that the localization of the specific sound is adjusted according to the sound collection result.

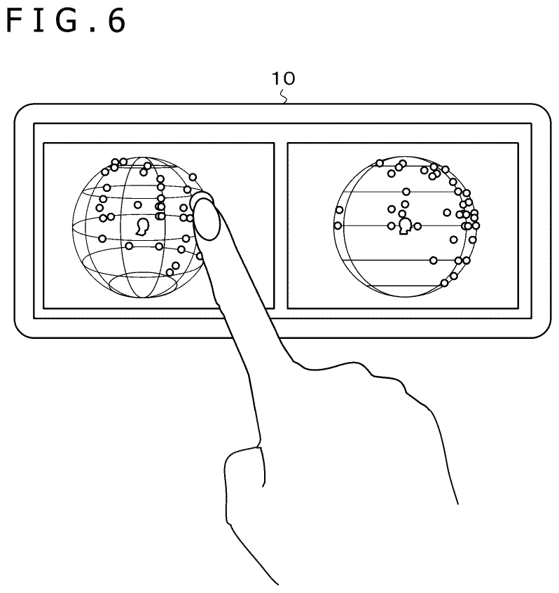

Moreover, for example, the desired setting described above can be achieved as described below. As illustrated in FIG. 6, for example, there is provided such a configuration that the user can move the localization of the specific sound to desired coordinates displayed by the application of the smartphone 10. Specifically, a diagram having three dimensional axes and having the user position at a center is displayed, and the localization of the specific sound can be adjusted to a favorite position in the diagram. As described above, the information processing apparatus 1 may be an information processing apparatus that allows the user to make a change to any setting in real time. This similarly applies to the setting for the adjustment of the clarity.

### 1-3. First Configuration Example of Signal Processing Section

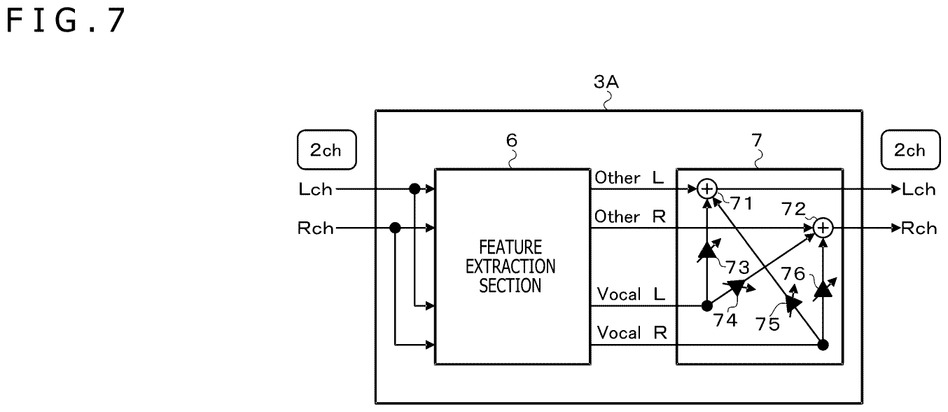

FIG. 7 illustrates a configuration example of the signal processing section 3 (denoted as a signal processing section 3A in FIG. 7) in a case in which the input signals are 2-channel signals. As illustrated in FIG. 7, the signal processing section 3A inputs the 2-channel (L-and-R-channel) signals as the input signals and outputs 2-channel signals as the output signals.

The signal processing section 3A includes a feature extraction section 6 and a feature addition section 7. The feature extraction section 6 extracts the signals of the specific sound from the input signals. The feature extraction section 6, for example, uses a learning model obtained through machine learning, to extract the signal of the specific sound (in the illustrated example, Vocal) from the input signal on each channel. This learning model is a learning model obtained by causing the learning model to learn, in advance, to extract the signal of the specific sound from the input signal. Note that, as the learning model, for example, a learning model which has learned for each channel may be used or a learning model common to the channels may be used.

As the machine learning, for example, a neural network (including a DNN (Deep Neural Network)) can be applied. With this configuration, the specific sound can accurately be extracted. Note that the machine learning is not limited to the neural network and may be machine learning performed through other methods such as the nonnegative matrix factorization (NMF), the k-nearest neighbor (k-NN), the support vector machine (SVM), and the Gaussian mixture model (GMM).

The feature extraction section 6, on the basis of this extraction result, separates the signal of the specific sound on each channel and the signal (Other in the illustrated example) of the sound other than the specific sound on each channel from each other and outputs these signals separated from each other. Each signal output from the feature extraction section 6 is supplied to the feature addition section 7. Note that the signal processing section 3A may be configured such that the input signals are directly supplied to the feature addition section 7 in place of the signals of the sound other than the specific sound. That is, there may be provided such a configuration that the input signals and the signals of the specific sound are supplied to the feature addition section 7. In this case, for example, delay processing is executed (for details, see a configuration example 2 described later).

The feature addition section 7 applies the gain adjustment to the signals of the specific sound extracted in the feature extraction section 6 and adds the signals obtained after the gain adjustment to the signals based on the input signals (in this example, the signals of the sound other than the specific sound). The feature addition section 7, for example, applies the gain adjustment to the signals of the specific sound with such a setting that the clarity of the specific sound changes or such a setting that the localization of the specific sound changes (the setting may be such that both the clarity and the localization change).

The feature addition section 7 includes addition sections 71 and 72 each of which adds input signals to one another and outputs a result of the addition and also includes gain adjustment sections 73 to 76 each of which adjusts the gain of an input signal and outputs a result of the gain adjustment. A signal (in the illustrated example, Vocal L) of the specific sound separated from an L channel signal is supplied to the addition section 71 via the gain adjustment section 73 and is supplied to the addition section 72 via the gain adjustment section 74. Moreover, a signal (in the illustrated example, Vocal R) of the specific sound separated from an R channel signal is supplied to the addition section 71 via the gain adjustment section 75 and is supplied to the addition section 72 via the gain adjustment section 76.

Each of the gain adjustment sections 73 to 76 is controlled according to the setting information output by the setting section 2 described before. For example, in the case of the fixed setting described before, each of the gain adjustment sections 73 to 76 applies the gain adjustment to the signal of the specific sound with the predetermined fixed setting. For example, in the case of the automatic setting described before, each of the gain adjustment sections 73 to 76 automatically applies the gain adjustment to the signal of the specific sound according to the sensing information of the sensor devices 5. Each of the gain adjustment sections 73 to 76, for example, may apply the gain adjustment to the signal of the specific sound according to the user age or the user position obtained by analyzing an image captured by the camera 51 or may apply the gain adjustment to the signal of the specific sound according to the level of the external noise obtained by analyzing the collected sound information obtained by the microphone 52. Moreover, for example, in the case of the desired setting described before, each of the gain adjustment sections 73 to 76 applies, as desired, the gain adjustment to the signal of the specific sound according to the operation information output from the user interface.

Meanwhile, a signal (in the illustrated example, Other L) of the sound other than the specific sound on the L channel is supplied to the addition section 71, and a signal (in the illustrated example, Other R) of the sound other than the specific sound on the R channel is supplied to the addition section 72. The addition section 71 adds the signals of the specific sound obtained after the gain adjustment by the gain adjustment section 73 and the gain adjustment section 75 to the signal of the sound other than the specific sound on the L channel and outputs a result of the addition. The addition section 72 adds the signals of the specific sound obtained after the gain adjustment by the gain adjustment section 74 and the gain adjustment section 76 to the signal of the sound other than the specific sound on the R channel and outputs a result of the addition. After that, the signal processing section 3A outputs the signals output by the addition section 71 and the addition section 72, as the L and R channel signals, respectively.

With the configuration described above, the signal processing section 3A can make the adjustment of the clarity and the adjustment of the localization of the specific sound. In a case in which the clarity of the specific sound is to be adjusted, it is only required to control each of the gain adjustment sections 73 to 76 such that the clarity of the specific sound of the output signals increases or decreases compared with that of the input signals. For example, the gains of the signals of the specific sound on the L and R channels to be added to the signal of the sound other than the specific sound on the L channel in the addition section 71 are increased by the gain adjustment section 73 and the gain adjustment section 76, respectively. With this configuration, each signal level of the specific sound is increased compared with that of the input signal, to emphasize the specific sound, thereby being able to increase the clarity. Moreover, for example, the audio can be suppressed, thereby being able to reduce the clarity by reducing these gains by the gain adjustment section 73 and the gain adjustment section 76. In other words, it is possible to emphasize a sound component other than the specific sound. With this configuration, for example, in the case of the music content, the vocal is suppressed, thereby being able to achieve a karaoke effect.

Moreover, in a case in which the localization of the specific sound is to be adjusted, it is only required to control each of the gain adjustment sections 73 to 76 such that the specific sound is localized to a desired position. For example, the signal of the specific sound extracted on each channel is mixed with one output channel side, and a mixed amount with the other channel side is reduced, thereby panning the signal of the specific sound to the one side. With this configuration, the adjustment of the localization can be achieved. Specifically, the gains of the signals of the specific sound on the L and R channels to be added to the signal of the sound other than the specific sound on the L channel in the addition section 71 are reduced by the gain adjustment section 73 and the gain adjustment section 75, respectively. Moreover, the gains of the signals of the specific sound component on the L and R channels to be added to the signal of the sound other than the specific sound on the R channel in the addition section 72 are increased by the gain adjustment section 74 and the gain adjustment section 76, respectively. With this configuration, there can be made such adjustment of the localization that the specific sound component on the L channel signal is reduced, the specific sound component on the R channel signal is increased, and hence, the specific sound is listened mainly on the right channel and the like.

Note that, in a case in which both the adjustment of the clarity and the adjustment of the localization of the specific sound are to be made, it is only required to appropriately control the gain adjustment sections 73 to 76 in consideration both the clarity and the localization. In a case in which the adjustment of the clarity and the adjustment of the localization of the specific sound are not to be made, it is only required to control each of the gain adjustment sections 73 to 76 such that the input signals are directly output. As described above, with the signal processing section 3A, the adjustment of the clarity and the adjustment of the localization of the specific sound can be made, and hence, the experience value of the content can be created.

### 1-4. Second Configuration Example of Signal Processing Section

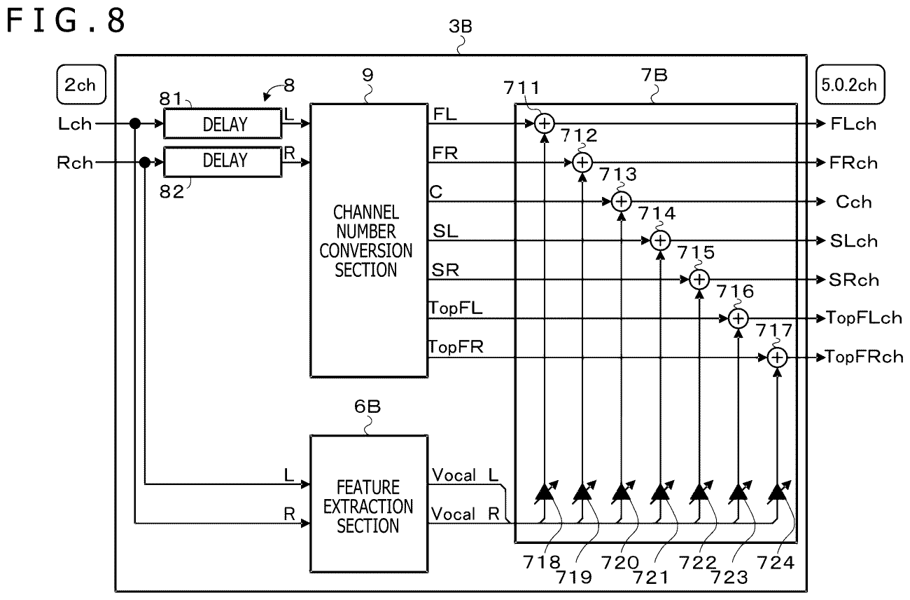

FIG. 8 illustrates a configuration example of the signal processing section 3 (denoted as a signal processing section 3B in FIG. 8) in a case in which upmixing processing accompanies. As illustrated in FIG. 8, the signal processing section 3B inputs the 2-channel (L-and-R-channel) signals as the input signals and outputs 5.0.2-channel signals (FL, FR. C. SL, SR, TopFL, and TopFR signals) as the output signals.

The FL and FR signals are signals for front left and right, respectively, and the C signal is a signal for front center. The SL and SR signals are signals for surround left and right, respectively. The TopFL and TopFR signals are signals for top front left and right, respectively.

The signal processing section 3B includes a feature extraction section 6B, a feature addition section 7B, a delay processing section 8, and a channel number conversion section 9. The feature extraction section 6B uses a learning model obtained through machine learning, to extract a signal of the specific sound on each channel from the 2-channel signals and outputs the extracted signals. Each signal output from the feature extraction section 6B is supplied to the feature addition section 7B. Note that these machine learning and learning model are as described before in the first configuration example, and hence, a description thereof is omitted.

Meanwhile, the channel number conversion section 9 changes the number of channels of the input signals and outputs signals obtained after the change. The channel number conversion section 9 specifically uses the upmixing technology to covert the 2-channel signals input trough the delay processing section 8 to the 5.0.2-channel signals and outputs the signals (FL, FR. C. SL, SR, TopFL, and TopFR signals) obtained after the conversion. As the upmixing technology, various technologies can be employed. Each signal output from the channel number conversion section 9 is supplied to the feature addition section 7B.

Note that the delay processing section 8 applies the delay processing to the input 2-channel signals and is provided to resolve, when signals of the specific sound are composed in the feature addition section 7B, deviations caused by processing delays having occurred in the feature extraction section 6B (specifically, delays at the time of the specific sound extraction processing through use of the learning model (learned data) of the machine learning, that is, analysis times for the specific sound extraction), thereby achieving matching. That is, the delay processing section 8 delays the output of each signal output from the channel number conversion section 9 according to the processing time (for example, 256 samples) in the feature extraction section 6B. The delay processing section 8, for example, applies the delay processing to each of the input 2-channel signals through use of each of delays 81 and 82 and outputs signals obtained after the delay processing.

The feature addition section 7B applies the gain adjustment to the signals of the specific sound extracted in the feature extraction section 6B and adds the signals obtained after the gain adjustment to the signals based on the input signals (in this example, the signals obtained after the upmixing). The feature addition section 7B, for example, applies the gain adjustment to the signals of the specific sound with a setting for changing the clarity of the specific sound or a setting for changing the localization of the specific sound (the setting may be such that both the clarity and the localization change).

The feature addition section 7B includes addition sections 711 to 717 each of which adds input signals to one another and outputs a result of the addition and also includes gain adjustment sections 718 to 724 each of which adjusts the gain of an input signal and outputs a result of the gain adjustment. Note that each of the gain adjustment sections 718 to 724 applies the gain adjustment to the signals (in the illustrated example, Vocal L or Vocal R) of the specific sound output from the feature extraction section 6B. Each of the gain adjustment sections 718 to 724 is controlled according to the setting information output by the setting section 2 described before, as in the first embodiment.

The signals of the specific sound output from the feature extraction section 6B are supplied to each of the addition sections 711 to 717 via the gain adjustment sections 718 to 724, respectively. Meanwhile, the FL and FR signals output from the channel number conversion section 9 are supplied to the addition section 711 and the addition section 712, respectively. Moreover, the C signal output from the channel number conversion section 9 is supplied to the addition section 713, and the SL and SR signals are supplied to the addition section 714 and the addition section 715, respectively. Further, the TopFL and TopFR signals output from the channel number conversion section 9 are supplied to the addition section 716 and the addition section 717, respectively.

The addition sections 711 to 717 add the signals of the specific sound on the 2 channels to which the gain adjustment is applied by the gain adjustment sections 718 to 724, respectively, to each of the multi-channel signals output from the channel number conversion section 9, respectively, and output results of the addition. The addition section 711 adds the signals of the specific sound to the FL signal and outputs a result of the addition, the addition section 712 adds the signals of the specific sound to the FR signal and outputs a result of the addition, and the addition section 713 adds the signals of the specific sound to the C signal and outputs a result of the addition. Moreover, the addition section 714 adds the signals of the specific sound to the SL signal and outputs a result of the addition, the addition section 715 adds the signals of the specific sound to the SR signal and outputs a result of the addition, the addition section 716 adds the signals of the specific sound to the TopSL signal and outputs a result of the addition, and the addition section 717 adds the signals of the specific sound to the TopSR signal and outputs a result of the addition. After that, the signal processing section 3B outputs the output signals of the addition sections 711 to 717 as the 5.0.2-channel signals.

With the configuration described above, the signal processing section 3B can make the adjustment of the clarity of the specific sound and the adjustment of the localization of the specific sound. In a case in which the clarity of the specific sound is to be adjusted, it is only required to control each of the gain adjustment sections 718 to 724 such that the clarity of the specific sound of the output signals increases or decreases compared with a case in which the specific sound is not added. For example, in a case in which a sound source of the specific sound such as the vocal or the like of the music content is positioned at the center position, the gains of the signals of the specific sound on the two channels to be added to the C signal in the addition section 713 are increased by the gain adjustment section 720. With this configuration, the signal level of the specific sound of the C signal to be output increases compared with the signal level available before the addition, and hence, the specific sound is emphasized, thereby being able to increase the clarity. Moreover, for example, these gains are reduced by the gain adjustment section 720. With this configuration, the signal level of the specific sound of the C signal to be output decreases compared with the signal level available before the addition, and hence, the specific sound is suppressed, thereby being able to reduce the clarity. That is, as in the first embodiment, the karaoke effect can be achieved. Note that the signal to be adjusted is not limited to the C signal and, for example, in a case in which the sound source of the specific sound does not at the center position, signals may be adjusted according to the sound source direction.

Moreover, in a case in which the localization of the specific sound is to be adjusted, it is only required to control each of the gain adjustment sections 718 to 724 such that the specific sound is localized to a desired position. For example, it is possible to adjust the localization of the specific sound toward the TopFL side by increasing the gains of the signals of the specific sound to be added to the TopFL signal and reducing the gains of the signals of the specific sound to be added to signals on other channels. Note that, in a case in which the adjustment of the clarity and the adjustment of the localization are to be made, the channel the level of the signal of the specific sound on which is increased or reduced is not limited to one channel and may be multiple channels.

In a case in which both the adjustment of the clarity and the adjustment of the localization of the specific sound are to be made, it is only required to appropriately control the gain adjustment sections 718 to 724 in consideration both the clarity and the localization. In a case in which the adjustment of the clarity and the adjustment of the localization of the specific sound are not to be made, it is only required to control each of the gain adjustment sections 718 to 724 such that the signal obtained immediately after the upmixing is directly output.

As described above, with the signal processing section 3B, the extraction of the specific sound by the feature extraction section 6B is executed in parallel with the processing performed by the delay processing section 8 and the channel number conversion section 9, and the extracted specific sound is caused to be composed with the signals obtained after the upmixing by the channel number conversion section 9. At this time, the adjustment of the clarity and the adjustment of the localization can be achieved by appropriately applying the gain adjustment to the signals of the specific sound to be composed, thereby being able to create the experience value of the content. Note that the channel configuration may be a configuration other than the conversion from the 2 channels to the 5.0.2 channels. Moreover, also in a case in which the up/down is to be executed, the adjustment of the clarity and the adjustment of the localization can similarly be made.

Moreover, when the processing for the upmixing is executed, the clarity of sound such as voice normally decreases, but it is possible to prevent the user from sensing the decrease in clarity, by increasing the clarity as described above.

### 1-5. Third Configuration Example of Signal Processing Section

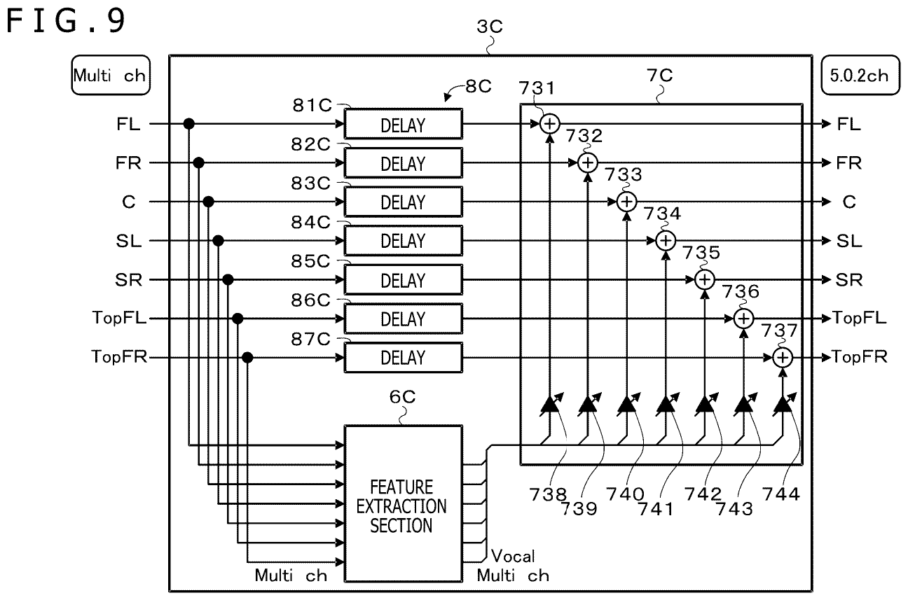

FIG. 9 illustrates a configuration example of the signal processing section 3 (denoted as a signal processing section 3C in FIG. 9) in a case in which the input signals are multi-channel signals. As illustrated in FIG. 9, the signal processing section 3C inputs 5.0.2-channel signals as the input signals and outputs 5.0.2-channel signals as the output signals.

The signal processing section 3C includes a feature extraction section 6C, a feature addition section 7C, and a delay processing section 8C. The feature extraction section 6C uses a learning model obtained through machine learning, to extract a signal (Vocal FL, Vocal FR, . . . , or Vocal TopFR) of the specific sound on each channel from the 5.0.2-channel 31 SYP346370US01 signals and outputs the extracted signals. Each signal output from the feature extraction section 6C is supplied to the feature addition section 7C. Note that these machine learning and learning model are also as described before in the first configuration example.

The delay processing section 8C applies the delay processing to the input 5.0.2-channel signals and is provided to resolve the deviation caused by the processing delay having occurred in the feature extraction section 6C when the specific sound is composed in the feature addition section 7C. That is, the delay processing section 8C delays output of the input 5.0.2-channel signals according to the processing time in the feature extraction section 6C. The delay processing section 8C, for example, applies the delay processing to each of the input 5.0.2-channel signals through use of each of delays 81C and 87C and outputs signals obtained after the delay processing. Each signal output from the delay processing section 8C is supplied to the feature addition section 7C.

The feature addition section 7C applies the gain adjustment to the signals of the specific sound extracted in the feature extraction section 6C and adds the signals obtained after the gain adjustment to the signals based on the input signals (in this example, the signals obtained after the delay processing). The feature addition section 7C, for example, applies the gain adjustment to the signals of the specific sound with the setting for changing the clarity of the specific sound or the setting for changing the localization of the specific sound (the setting may be such that both the clarity and the localization change).

The feature addition section 7C includes addition sections 731 to 737 each of which adds input signals to one another and outputs a result of the addition and gain adjustment sections 738 to 744 each of which adjusts the gain of input signals and outputs a result of the gain adjustment. Note that each of the gain adjustment sections 738 to 744 applies the gain adjustment to each of the signals (in the illustrated example, Vocal Multich: Vocal FL, Vocal FR, . . . , and Vocal TopFR) of the specific sound output from the feature extraction section 6C. Each of the gain adjustment sections 738 to 744 is controlled according to the setting information output by the setting section 2 described before, as in the first embodiment.

The signals of the specific sound output from the feature extraction section 6C are supplied to the addition sections 731 to 737 via the gain adjustment sections 738 to 744, respectively. Meanwhile, the FL and FR signals output from the delay processing section 8C are supplied to the addition section 731 and the addition section 732, respectively. Moreover, the C signal output from the delay processing section 8C is supplied to the addition section 733, and the SL and SR signals are supplied to the addition section 734 and the addition section 735, respectively. Further, the TopFL and TopFR signals output from the delay processing section 8C are supplied to the addition section 736 and the addition section 737, respectively.

The addition sections 731 to 737 add the signals of the specific sound on the multi-channels to which the gain adjustment is applied by the gain adjustment sections 738 to 744, respectively, to each of the multi-channel signals output from the delay processing section 8C, and output results of the addition. The addition section 731 adds the signals of the specific sound to the FL signal and outputs a result of the addition, the addition section 732 adds the signals of the specific sound to the FR signal and outputs a result of the addition, and the addition section 733 adds the signals of the specific sound to the C signal and outputs a result of the addition. Moreover, the addition section 734 adds the signals of the specific sound to the SL signal and outputs a result of the addition, the addition section 735 adds the signals of the specific sound to the SR signal and outputs a result of the addition, the addition section 736 adds the signals of the specific sound to the TopSL signal and outputs a result of the addition, and the addition section 737 adds the signals of the specific sound to the TopSR signal and outputs a result of the addition. After that, the signal processing section 3C outputs the output signals of the addition sections 731 to 737 as the 5.0.2-channel signals.

With the configuration described above, the signal processing section 3C can make adjustment of the clarity of the specific sound and the adjustment of the localization of the specific sound. In a case in which the clarity of the specific sound is to be adjusted, it is only required to control each of the gain adjustment sections 738 to 744 such that the clarity of the specific sound of the output signals increases or decreases compared with the case in which the specific sound is not added. For example, in a case in which a sound source of the specific sound is positioned at the center position, the gains of the signals of the specific sound on the multi-channels to be added to the C signal in the addition section 733 are increased by the gain adjustment section 740. With this configuration, the specific sound can be emphasized, thereby being able to increase the clarity. Moreover, for example, these gains are reduced by the gain adjustment section 740. With this configuration, the specific sound is suppressed, thereby being able to reduce the clarity. That is, as in the first embodiment, the karaoke effect can be achieved. Note that, also in this case, the signal to be adjusted is not limited to the C signal and, for example, signals may be adjusted according to the sound source direction.

Moreover, in a case in which the localization of the specific sound is to be adjusted, it is only required to control each of the gain adjustment sections 738 to 744 such that the specific sound is localized to a desired position. For example, it is possible to adjust the localization of the specific sound toward the TopFL side by increasing the gains of the signals of the specific sound to be added to the TopFL signal and reducing the gains of the signals of the specific sound to be added to signals on other channels. Note that, in a case in which the adjustment of the clarity and the adjustment of the localization are to be made, the channel the level of the signal of the specific sound on which is increased or reduced is not limited to one channel and may be multiple channels.

In a case in which both the adjustment of the clarity and the adjustment of the localization of the specific sound are to be made, it is only required to appropriately control the gain adjustment sections 738 to 744 in consideration both the clarity and the localization. In a case in which the adjustment of the clarity and the adjustment of the localization of the specific sound are not to be made, it is only required to control each of the gain adjustment sections 738 to 744 such that each signal output from the delay processing section 8C is directly output.

As described above, with the signal processing section 3C, even in a case in which the input signals are the multi-channel signals, the adjustment of the clarity and the adjustment of the localization can be achieved, thereby being able to create the experience value of the content. Note that the channel configuration may be other than the 5.0.2 channels.

### 1-6. Example of Processing by Signal Processing Section

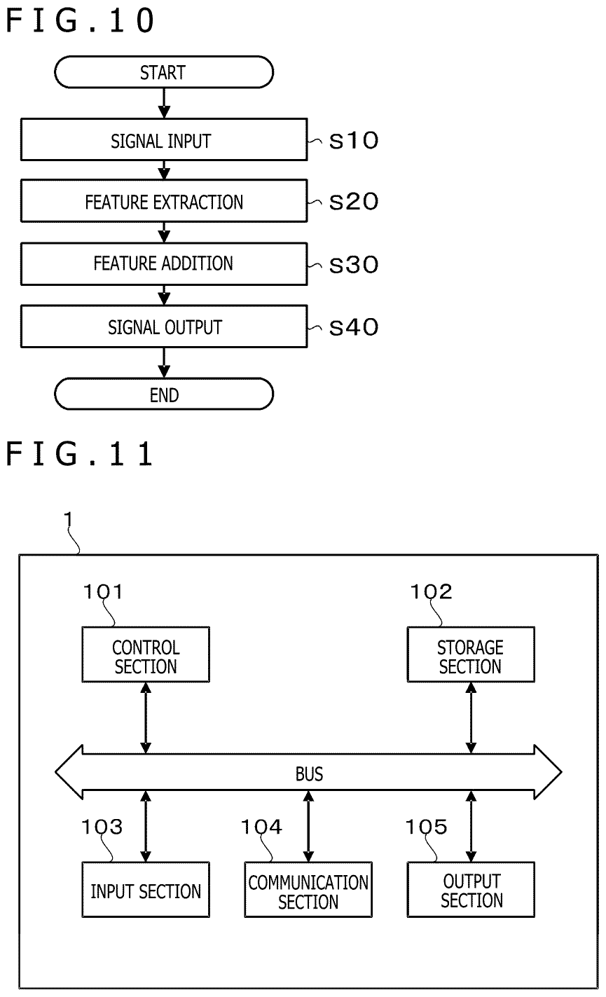

FIG. 10 illustrates the processing performed by the signal processing section 3 described above, as a flowchart. The signal processing section 3 inputs the input signals when the processing is started by, for example, a power supply being turned on (Step S10). After that, the signal processing section 3 uses the learning model obtained through the machine learning, to extract the signals of the specific sound from these input signals (feature extraction step: Step S20). After that, the signal processing section 3 appropriately adjusts the gains of these extracted signals of the specific sound and adds the results to the signals based on the input signals (feature addition step: Step S30). The gains of the signals of the specific sound to be added are appropriately adjusted according to the setting information output by the setting section 2 described before. As described above, the adjustment of the clarity and the adjustment of the localization of the specific sound can be achieved by adjusting the gains of the signals of the specific sound to be added. After that, the signal processing section 3 outputs, as the output signals, the signals to which these signals of the specific sound are added (Step S40). The signal processing section 3 ends the processing by, for example, the power supply being turned off.

### 1-7. Hardware Configuration Example

FIG. 11 illustrates a hardware configuration example of the information processing apparatus 1 described above. The information processing apparatus 1 includes a control section 101, a storage section 102, an input section 103, a communication section 104, and an output section 105 connected to one another via a bus.

The control section 101 includes, for example, a CPU (Central Processing Unit), a RAM (Rando Access Memory), a ROM (Read Only Memory), and the like. In the ROM, a program, for example, which is read and is operated by the CPU and the like are stored. The RAM is used as a work memory of the CPU. The CPU executes various types of processing according to the program stored in the ROM, to issue commands, thereby controlling the entire information processing apparatus 1.

The storage section 102 is a storage medium including, for example, an HDD (Hard Disk Drive), an SSD (Solid State Drive), a semiconductor memory, or the like and stores content data such as image data, motion image data, sound data, and text data as well as data such as the program (for example, an application).

The input section 103 is an apparatus for inputting various types of information to the information processing apparatus 1. When the information is input by the input section 103, the control section 101 executes various types of processing corresponding to this input information. The input section 103 may be a mouse and a keyboard as well as a microphone, various types of sensors, a touch panel, a touch screen uniformly formed with a monitor, a physical button, and the like. Note that the input of the various types of information to the information processing apparatus 1 may be configured such that the various types of information are input via the communication section 104 described below.

The communication section 104 is a communication module which communicates with another apparatus and the Internet on the basis of a predetermined communication standard. As a communication method, a wireless LAN (Local Area Network) such as the Wi-Fi (Wireless Fidelity), the LTE (Long Term Evolution), the 5G (fifth generation mobile communication system), broadband, the Bluetooth (registered trademark), and the like are known.

The output section 105 is an apparatus for outputting various types of information from the information processing apparatus 1. The output section 105 includes, for example, a display which displays an image and a video and an output device such as a speaker which outputs sound. Note that the output of the various types of information from the information processing apparatus 1 may be configured such that the various types of information are output via the communication section 104.

The control section 101, for example, reads and executes the program (for example, an application) stored in the storage section 102, thereby executing the various types of processing. That is, the information processing apparatus 1 has functions as a computer.

Note that the program (for example, an application) and the data may not be stored in the storage section 102. For example, the program and the data stored in a storage medium which can be read by the information processing apparatus 1 may be read and then used. As this storage medium, for example, an optical disc, a magnetic disk, a semiconductor memory, an HDD, and the like attachable/detachable to/from the information processing apparatus 1 are known. Moreover, the program and the data may be stored in an apparatus (for example, a cloud storage) connected to a network such as the Internet, and the information processing apparatus 1 may read and then execute the program and the data therefrom. Moreover, the program may be, for example, a plug-in-program which adds, to an existing application, a part of or all of the processing.

### 2. Modification Examples

The specific description has been given of the embodiment of the present disclosure, but the present disclosure is not limited to the embodiment described above, and various modifications based on the technical idea of the present disclosure can be made. For example, various modifications described now are possible. Moreover, freely-selected one or multiple aspects of the modification described now may appropriately be combined. Moreover, the configurations, the methods, the processes, the shapes, the materials, the numerical values, and the like of the embodiment described above can be combined with one another and can be replaced by one another unless the combinations and the replacement depart from the gist of the present disclosure. Moreover, a singular item can be divided into two or more, and a part of an item can also be omitted.

For example, in the embodiment described before, as the specific sound, the sound relating to the voice is exemplified, but the specific sound is not limited to the voice. For example, the specific sound is only required to be sound which can be extracted such as sound of a specific musical instrument, a sound effect, cheer sound, or noise (for example, noise externally mixed). For example, in a case in which the noise is extracted as the specific sound, the noise can be suppressed by providing the setting of reducing the clarity of the specific sound.

Moreover, for example, the gain adjustment sections 73 to 76 in the first configuration example, the gain adjustment sections 718 to 724 in the second configuration example, and the gain adjustment sections 738 to 744 in the third configuration example described before may be configured such that the user can directly adjust them via the user interface.

Note that the present disclosure can also adopt the following configurations.
(1)

A signal processing apparatus including:
a feature extraction section that uses a learning model obtained through machine learning, to extract a signal of specific sound from an input signal; and
a feature addition section that applies gain adjustment to the signal of the specific sound extracted in the feature extraction section and adds a result of the gain adjustment to a signal based on the input signal.
(2)

The signal processing apparatus according to (1), including:
a channel number conversion section that changes the number of channels of the input signal and outputs a result of the change,
in which the feature addition section adds the signal of the specific sound to the signal output from the channel number conversion section.
(3)

The signal processing apparatus according to (2),
in which the channel number conversion section uses an upmixing technology to increase the number of channels.
(4)

The signal processing apparatus according to any one of (1) to (3),
in which both the input signal and the signal based on the input signal are signals on multiple channels,
the feature extraction section extracts the signal of the specific sound from each channel signal of the input signals, and
the feature addition section applies the gain adjustment to each signal of the specific sound extracted in the feature extraction section and adds each result of the gain adjustment to each channel signal based on the input signal.
(5)

The signal processing apparatus according to any one of (1) to (4),
in which the feature addition section applies the gain adjustment to the signal of the specific sound with such a setting that clarity of the specific sound changes.
(6)

The signal processing apparatus according to (5),
in which the specific sound is a vocal of music content, and
the feature addition section reduces a gain as the gain adjustment.
(7)

The signal processing apparatus according to any one of (1) to (6),
in which the feature addition section applies the gain adjustment to the signal of the specific sound with such a setting that localization of the specific sound changes.
(8)

The signal processing apparatus according to any one of (1) to (7), including:
a delay processing section that delays output of the signal based on the input signal to the feature addition section according to a processing time in the feature extraction section.
(9)

The signal processing apparatus according to any one of (1) to (8),
in which the specific sound is sound relating to voice.
(10)

The signal processing apparatus according to any one of (1) to (8),
in which the specific sound is sound of a specific musical instrument, a sound effect, cheer, or noise.
(11)

The signal processing apparatus according to any one of (1) to (10),
in which the feature extraction section uses a DNN (Deep Neural Network) as the machine learning.
(12)

The signal processing apparatus according to any one of (1) to (11),
in which the feature addition section applies the gain adjustment to the signal of the specific sound with a predetermined fixed setting.
(13)

The signal processing apparatus according to any one of (1) to (12),
in which the feature addition section automatically applies the gain adjustment to the signal of the specific sound according to sensing information output from a sensor device.
(14)

The signal processing apparatus according to (13), in which a camera is included in the sensor device, and the feature addition section applies the gain adjustment to the signal of the specific sound according to a user age obtained by analyzing an image captured by the camera.
(15)

The signal processing apparatus according to (13) or (14),
in which a camera is included in the sensor device, and
the feature addition section applies the gain adjustment to the signal of the specific sound according to a user position obtained by analyzing an image captured by the camera.
(16)

The signal processing apparatus according to any one of (13) to (15),
in which a microphone is included in the sensor device, and
the feature addition section applies the gain adjustment to the signal of the specific sound according to a level of external noise obtained by analyzing collected sound information obtained by the microphone.
(17)

The signal processing apparatus according to any one of (1) to (16),
in which the feature addition section applies, as desired, the gain adjustment to the signal of the specific sound according to operation information output from a user interface.
(18)

A signal processing method including:
a feature extraction step of using a learning model obtained through machine learning, to extract a signal of specific sound from an input signal; and
a feature addition step of applying gain adjustment to the signal of the specific sound extracted in the feature extraction step and adding a result of the gain adjustment to a signal based on the input signal.

### REFERENCE SIGNS LIST

1: Information processing apparatus
2: Setting section
3, 3A, 3B, 3C: Signal processing section
6, 6B, 6C: Feature extraction section
7, 7B, 7C: Feature addition section
8, 8C: Delay processing section
9: Channel number conversion section
71, 72, 711 to 717, 731 to 737: Addition section
73 to 76, 718 to 724, 738 to 744: Gain adjustment section

1. A signal processing apparatus comprising:
a feature extraction section that uses a learning model obtained through machine learning, to extract a signal of specific sound from an input signal; and
a feature addition section that applies gain adjustment to the signal of the specific sound extracted in the feature extraction section and adds a result of the gain adjustment to a signal based on the input signal.

2. The signal processing apparatus according to claim 1, comprising:
a channel number conversion section that changes the number of channels of the input signal and outputs a result of the change,
wherein the feature addition section adds the signal of the specific sound to the signal output from the channel number conversion section.

3. The signal processing apparatus according to claim 2,
wherein the channel number conversion section uses an upmixing technology to increase the number of channels.

4. The signal processing apparatus according to claim 1,
wherein both the input signal and the signal based on the input signal are signals on multiple channels,
the feature extraction section extracts the signal of the specific sound from each channel signal of the input signals, and
the feature addition section applies the gain adjustment to each signal of the specific sound extracted in the feature extraction section and adds each result of the gain adjustment to each channel signal based on the input signal.

5. The signal processing apparatus according to claim 1,
wherein the feature addition section applies the gain adjustment to the signal of the specific sound with such a setting that clarity of the specific sound changes.

6. The signal processing apparatus according to claim 5,
wherein the specific sound is a vocal of music content, and
the feature addition section reduces a gain as the gain adjustment.

7. The signal processing apparatus according to claim 1,
wherein the feature addition section applies the gain adjustment to the signal of the specific sound with such a setting that localization of the specific sound changes.

8. The signal processing apparatus according to claim 1, comprising:
a delay processing section that delays output of the signal based on the input signal to the feature addition section according to a processing time in the feature extraction section.

9. The signal processing apparatus according to claim 1,
wherein the specific sound is sound relating to voice.

10. The signal processing apparatus according to claim 1,
wherein the specific sound is sound of a specific musical instrument, a sound effect, cheer sound, or noise.

11. The signal processing apparatus according to claim 1,
wherein the feature extraction section uses a DNN (Deep Neural Network) as the machine learning.

12. The signal processing apparatus according to claim 1,
wherein the feature addition section applies the gain adjustment to the signal of the specific sound with a predetermined fixed setting.

13. The signal processing apparatus according to claim 1,
wherein the feature addition section automatically applies the gain adjustment to the signal of the specific sound according to sensing information output from a sensor device.

14. The signal processing apparatus according to claim 13,
wherein a camera is included in the sensor device, and
the feature addition section applies the gain adjustment to the signal of the specific sound according to a user age obtained by analyzing an image captured by the camera.

15. The signal processing apparatus according to claim 13,
wherein a camera is included in the sensor device, and
the feature addition section applies the gain adjustment to the signal of the specific sound according to a user position obtained by analyzing an image captured by the camera.

16. The signal processing apparatus according to claim 13,
wherein a microphone is included in the sensor device, and
the feature addition section applies the gain adjustment to the signal of the specific sound according to a level of external noise obtained by analyzing collected sound information obtained by the microphone.

17. The signal processing apparatus according to claim 1,
wherein the feature addition section applies, as desired, the gain adjustment to the signal of the specific sound according to operation information output from a user interface.

18. A signal processing method comprising:
a feature extraction step of using a learning model obtained through machine learning, to extract a signal of specific sound from an input signal; and
a feature addition step of applying gain adjustment to the signal of the specific sound extracted in the feature extraction step and adding a result of the gain adjustment to a signal based on the input signal.
